(19) United States
(12) Patent Application Publication
(10) Pub. No.: US 2006/0045153 A1
(43) Pub. Date: Mar. 2, 2006

(54) Low thermal expansion coefficient cooler for diode-laser bar

(76) Inventors: Serrena M. Carter, Fremont, CA (US); Robert Martinsen, Morgan Hill, CA (US)

Correspondence Address: STALLMAN & POLLOCK LLP, 353 SACRAMENTO STREET, SUITE 2200, SAN FRANCISCO, CA, 94111, US

(21) Appl. No.: 10/930,085

(22) Filed: Aug. 31, 2004

(51) Int. Cl. H01S 3/04

(52) U.S. Cl. 372/35; 372/34; 372/36

(57) ABSTRACT

A heat sink for cooling a diode-laser bar on a gallium arsenide (GaAs) substrate includes a water-cooled copper body. A layer of a metal having a coefficient of expansion (CTE) about equal to or greater than that of gallium arsenide but less than that of copper is bonded to each of two opposite surfaces of the body. A layer of copper is bonded each of the lower-CTE layers. The copper layers each have a thickness less than that of the lower-CTE layers and are under tensile strain. This provides that when a GaAs diode-laser bar is soldered to the heat sink the copper layers do not expand any more than the lower-CTE layers differential expansion between the copper and the lower CTE material merely reduces the tensile strain in the layers.

### TECHNICAL FIELD OF THE INVENTION

The present invention relates generally to coolers for semiconductor devices. The invention relates in particular to a coefficient-of-thermal-expansion-matched cooler for a diode-laser bar.

### DISCUSSION OF BACKGROUND ART

A diode-laser bar is a term commonly used for a linear array of diode-laser emitters formed in a single substrate. The “bar” usually has a length of about 1.0 centimeter (cm) and a width between about 1.0 and 1.5 millimeters (mm). The bar includes a substrate of a semiconductor material supporting epitaxially grown semiconductor layers in which the emitters are formed. A common substrate material for the bar is Gallium Arsenide (GaAs). The bar may include up to one-hundred individual diode-lasers (emitters), depending on the width of the emitters and the packing density of the emitters in the bar. Each emitter occupies an elongated “stripe” in the bar with the length direction of the stripe being in the width direction of the bar. Each emitter emits light from an emitting area in the edge of the bar. The emitting area may have a width from a few micrometers (μm) to about 150 μm. The height of the emitting area is about 1.0 μm.

Electrical current is passed through the emitters of a diode-laser bar to cause the emitters to emit light. About 45% of the power of the electrical current is converted to emitted light. The remaining power produces heat, due to the resistance of the bar to the passage of the electrical current. This heat must be removed to ensure satisfactory operation of the bar. Heat removal is usually accomplished by bonding the bar in thermal contact with a fluid-cooled (usually water-cooled) heat-sink or cooler. The heat sink usually comprises a copper (Cu) body having cooling channels therein through which cooling fluid passes. Copper is preferred as a cooler material because of the high thermal conductivity of copper.

A copper heat sink has a significantly higher coefficient of thermal expansion (CTE) than that of GaAs. Cu has a CTE of about 17 parts per million per degree Celsius (17 ppm/° C.) while GaAs has a CTE of only about 5.6 ppm/° C. This CTE difference (mismatch) between the Cu and the GaAs is detrimental to both reliability and optical performance of a diode-laser bar. By way of example, due to the CTE mismatch thermal cycling of the diode-laser bar during the normal course of operation can cause complete failure of the diode-laser bar after as few as 2000 cycles. Bond-induced stress in a diode-laser bar due to the CTE mismatch can cause a misalignment of emitting areas of the bar from a truly linear alignment. This misalignment is usually whimsically termed “smile” by practitioners of the art, and can adversely affect optical arrangements for coupling of light from the diode-laser bar into optical fibers. Bond-induced stress in a diode-laser bar due to the CTE mismatch can also cause an increase in spectral width of light emitted by the bar. This is a problem if light from the diode-laser bar is used for optically pumping a solid-state gain medium. There is a need for a fluid-cooled heat sink that offers the same high thermal conductivity of copper but provides for a CTE-matched bond between the heat sink and a diode-laser bar thereon.

### SUMMARY OF THE INVENTION

The present invention is directed to a cooler for a diode-laser formed on a semiconductor substrate. In one aspect, the apparatus comprises a body of a first metal having first and second opposite surfaces. A first layer of a second metal is bonded to the first surface of the body. The second metal has a coefficient of thermal expansion (CTE) equal to or greater than that of the substrate, but less than that of the first metal. A first layer of a third metal is bonded to the first layer of the second metal. The third metal has a CTE and a thermal conductivity greater than that of the second metal.

Preferably a second layer of the second metal is bonded to the second surface of the body. This layer preferably also has a layer of the third metal bonded thereto, and has a thickness less than that of the second layer of the second metal. Both second-metal layers preferably have the same thickness, and both third-metal layers preferably also have the same thickness.

The body may be a fluid cooled body having channels therein for passing a fluid therethrough. The first layer of the third metal preferably has a thickness less than that of the first layer of the second metal.

In one example of the inventive cooler for a diode-laser bar on a GaAs substrate, the metal body is made from copper and is water cooled. The second metal is 30:70 copper-molybdenum (Cu:Mo) alloy, and the layers thereof each have a thickness of about five-thousandths of an inch (0.005″). The third-metal layers are copper layers bonded and each has a thickness of about 0.002″.

The Cu:Mo layers are bonded to the copper body and the copper layers are bonded to Cu:Mo layers by high temperature (for example, about 1000° C.) diffusion bonding. The copper layers are formed from initially thicker layers that are machined to a final thickness. The copper layers are highly strained, in tension, as a result of the diffusion bonding process. This reduces the expansion of a copper layer when a diode-laser bar is soldered thereto. The copper layer to which the diode-laser bar is soldered serves as heat spreader to spread heat away from the diode-laser bar before the heat reaches the Cu:Mo layer, which is less thermally conductive than the copper layer.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a cross-section view schematically illustrating a diode-laser bar mounted on one embodiment of a cooler in accordance with the present invention, the cooler including a copper body having cooling channels therein for circulating a cooling fluid therethrough, and the body having bonded to thereto a layer of metal having a CTE matching the CTE of the diode-laser bar with a strained layer of copper bonded to the CTE matching layer.

FIG. 2 is a is a cross-section view schematically illustrating a diode-laser bar mounted on another embodiment of a cooler in accordance with the present invention the cooler including a body made of a metal having a CTE matching the CTE of the diode-laser bar, with a strained layer of copper bonded to the body.

### DETAILED DESCRIPTION OF THE INVENTION

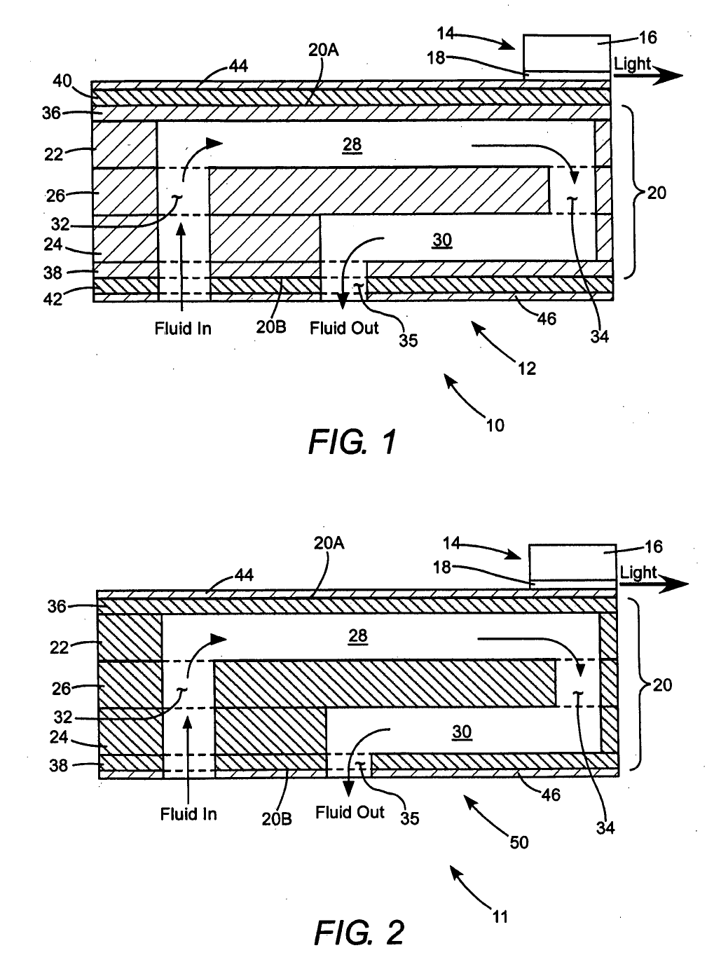

Referring now to the drawings, wherein like features are designated by like reference numerals. FIG. 1 schematically depicts apparatus 10 including a preferred embodiment 12 of a cooler in accordance with the present invention. Mounted on the cooler in thermal contact therewith is a diode-laser bar 14 (seen here in an end view). Diode-laser bar 14 has a substrate 16 on which are grown (supported) layers 18 (collectively depicted) in which individual emitters of the diode-laser bar are formed.

Cooler 12 includes a main body portion 20. Body 20, here, includes a fluid-inlet layer 22, a fluid-outlet layer 24. Layers 22 and 24 have a separator layer 26 therebetween. Fluid-inlet layer 22 has machined therethrough a volume 28 that may be a continuous space or serpentine channels. Fluid-outlet layer 24 has a similar volume 30 machined therethrough. Volumes 28 and 30 are in fluid communication via an aperture 32 machined through separator layer 26. Aperture 32 extending through layers 24 and 26 (and other layers described below) provides for admission of fluid into inlet volume 28. The direction of cooling-fluid flow is indicated by arrows. This flow direction is merely exemplary. Fluid can be flowed through body 20 in an opposite direction to that indicated without departing from the spirit and scope of the present invention.

Inlet volume 28 is covered by a cap layer 36, and volume 30 is covered by a cap layer 38. Layers 22, 24, 26, 36, and 38 are preferably formed from copper but may be formed from any other metal or alloy having a similarly high thermal conductivity such as molybdenum or an alloy of copper or molybdenum. Cap layers 36 and 38 provide opposite surfaces 20A and 20B of body 20. It is important that all layers forming body 20 are of the same material. In layers of different materials having extensive contact with cooling liquid, galvanic corrosion can occur. Such corrosion can eventually cause fluid leakage between the bonded dissimilar layers. Preferably layers of the body material are of a metal having a relatively high thermal conductivity, for example, copper. Bonded to cap layers 36 and 38 of body 20 are CTE-matching layers 40 and 42 respectively. These layers 40 and 42 are layers of a metal preferably having a CTE similar to that of substrate 16 of diode-laser 14. Ideally, the CTE of layers 40 and 42 should be equal to that of substrate 16, however, the CTE can be about 50% greater than that of the substrate. This allows for selection of a material that combines a CTE close to that of the substrate with relatively high thermal conductivity.

By way of example, molybdenum has a CTE of about 5.5 ppm/° C., which is very close to that of GaAs (5.6) ppm/° C. Molybdenum, however, has a thermal conductivity of only 142 Watts per meter per degree Kelvin (W/m°K) while annealed copper has a thermal conductivity of about 385 W/m°K. Alloys of molybdenum and copper can provide increasing thermal conductivity with increasing copper content at the expense of an increasing CTE. A preferred metal for layers 40 and 42 (when substrate 16 is a GaAs substrate) is a 30:70 Cu:Mo alloy having a CTE of 7.8 ppm/° C. and a thermal conductivity of 200 W/m°K. Alloys of copper and tungsten may also be used for layers 40 and 42.

Continuing with reference to FIG. 1, bonded to CTE-matching layers 40 and 42 are heat spreader layers 44 and 46, respectively. Heat spreader layers 44 and 46 should be of a metal having a higher CTE that that of the layers 40 and 42, and are preferably layers of copper. The layers preferably have a thickness less than that of CTE-matching layers 40 and 42, with a thickness between about 0.003″ and 0.001″ being preferred. It is important that these layers are under tensile strain. The tensile strain together with the relative “thinness” of the spreader layers provides that when a diode-laser is bonded to one of the layers (layer 44 in FIG. 1) by low temperature solder-bonding, layer 44 does not thermally expand any more than the CTE-matching layer. Instead the thermal strain in layer 44 is reduced. If a spreader layer is made too thin, of course, effectiveness of the layer for heat spreading will be compromised. It should be noted, here that while both layers 44 and 46 are referred to as heat spreader layers, only layer 44 functions as such in the assembly shown. Layer 46, and corresponding CTE-matching layer 42 function primarily to provide a symmetrical layer structure to minimize thermal distortion of the structure during assembly or during operation.

In a preferred method of assembling a cooler 12, layers 22, 24, 26, 38, 42, and 46 are lithographically patterned and etched to provide apertures therethrough for providing the inlet and outlet water volumes 28 and 30, conduit 34 for connecting the inlet and outlet volumes, conduit 32 for supplying fluid to the inlet volume, and conduit 35 for draining fluid from the outlet volume. The etched layers are then stacked together with cap layer 36, CTE-matching layer 40, and heat spreader layer 44, then layers in the stack are bonded together by high temperature diffusion bonding, under pressure. For the Cu and 30:70 Co:Mo layers discussed above, a bonding temperature of about 1000° C. is preferred. Heat spreader layers 44 and 46 are initially about twice as thick as the desired final thickness thereof, and are machined to the final thickness after assembly bonding is complete. As the assembly is cooled after the bonding, tensile strain builds up in layers 44 and 46 as a result of differential thermal contraction between these layers and CTE-matching layers 40 and 42 to which the layers are bonded.

It should be noted here that while high temperature diffusion bonding is a most preferred method for bonding layers of the inventive cooler, another high temperature bonding method such as high temperature brazing may also be used. As noted above, it is the high temperature aspect of the bonding process that creates the tensile stress in the heat spreader layers 44 and 46.

In an experiment to assess effectiveness of one example of the inventive cooler a number assemblies of diode-laser bar and inventive cooler were performance tested and compared with similar assemblies in which a prior-art, all-copper, cooler was used. In this example of the inventive cooler, layers 22 and 24 are Cu layers each having a thickness of 0.012″; layer 26 is a Cu layer having a thickness of 0.008″; layers 36 and 38 are Cu layers each having a thickness of 0.004″; layers 40 and 42 are 30:70 Cu:Mo layers each having a thickness of 0.005″; and layers 44 and 46 are Cu layers each having a thickness of 0.002″. Diode-laser bar 14 has a length of about 1.0 cm and a width of about 1.0 mm and includes 49 emitters about 100 μm wide with a 50% fill-factor. Substrate 16 is a GaAS substrate and the emitters emit light having a nominal wavelength of 808 nm. Twenty-six assemblies incorporating the inventive cooler were evaluated and compared with fifteen assemblies incorporating a prior-art, all-copper cooler.

Diode-laser bars in the inventive cooler assemblies provided light with a average spectral width (full width at half maximum—FHWM) of 2.22 nm, while comparison samples provided an average spectral width of 3.34 nm. Polarization ratio of light from diode-laser bars in the inventive cooler assemblies averaged 905.75 compared with only 12.28 for diode-laser bars on the prior-art coolers. The average “smile” of diode-laser bars on the inventive coolers is 1.0 μm compared with 2.47 μm for the diode-laser bars on prior-art coolers.

Referring now to FIG. 2, apparatus 11 includes another embodiment 50 of a cooler in accordance with the present invention. A diode-laser 14 is bonded to the cooler as described above with reference to apparatus 10. Cooler 50 is constructed in a similar manner to cooler 12 of FIG. 1 with an exception that body portion 20 thereof is made from layers 22, 24, and 26 of a material that preferably has a CTE similar to that of substrate 16 and CTE matching layers 40 and 42 of cooler 12 are omitted. The terminology “similar to”, as applied to the CTE of the body material and the substrate, means that the CTE of the body material is preferably within about 50% of the CTE of substrate 16 as discussed above with reference to the CTE matching layers. For a substrate 16 of GaAs, suitable metals for layers of body 20 include molybdenum, alloys of copper and molybdenum, and alloys of copper and tungsten. Alloys of copper and tungsten, however, can not be readily worked by lithographic patterning and etching.

Bonded directly to surfaces 20A and 20B of body 20, i.e., onto cap layers 36 and 38, are copper layers 44 and 46 respectively. Layers of cooler 50 are preferably assembled and bonded by high temperature diffusion bonding as discussed above with reference to cooler 12. Copper layers 44 and 46 will be in tensile strain when the bonded assembly is cooled due to differential contraction between the body layers and layers 44 and 46. In cooler 50, heat spreader layer 44 has the same function as layer 44 of cooler 12, i.e., to spread heat from diode-laser 14 facilitate removal of the heat by the fluid cooled body of the cooler. As cooler 50 does not have a separate CTE-matching layer (CTE matching being provided by the body), the thickness of metal between spreader layer 44 and cooling fluid circulating in the body is reduced. This compensates for using a material for body 20 that has a lower thermal conductivity than that of copper. As all layers of body 20 are made from the same material, the above-discussed problem of galvanic corrosion is avoided.

The present invention is discussed in terms of a preferred and other embodiments. The invention is not limited, however, to the embodiments described and depicted. Rather, the invention is limited only by the claims appended hereto.

What is claimed is:

1. Apparatus for cooling a diode-laser formed on a semiconductor substrate, comprising:
a body of a first metal, said metal body having channels therein for circulating a cooling fluid therethrough, and said body having first and second opposite surfaces;
a first layer of a second metal bonded to said first surface of said body, said second metal having a coefficient of thermal expansion (CTE) equal to or greater than that of said substrate but less than that of said first metal; and
a first layer of a third metal having a thickness less than that of first layer of said second metal and being bonded to said first layer of said second metal, said third metal having a CTE and a thermal conductivity greater than that of said second metal.

2. The apparatus of claim 1, wherein said second metal has a CTE within about 50% of that of said substrate.

3. The apparatus of claim 1, wherein said first and third metals are the same.

4. The apparatus of claim 1, further including a second layer of said second metal bonded to said second surface of said metal body, said second layer of said second metal having a second layer of said third metal bonded thereto, said second layer of said third metal having a thickness less than that of said second layer of said second metal.

5. The apparatus of claim 4, wherein said first and second layers of said second metal are about equal in thickness, and said first and second layers of said third metal are about equal in thickness.

6. The apparatus of claim 1, wherein said third metal is copper.

7. The apparatus of claim 1, wherein said first metal is copper.

8. The apparatus of claim 7, wherein said third metal is copper.

9. The apparatus of claim 8, wherein the substrate is a gallium arsenide substrate and said second metal is selected from the group of metals consisting of molybdenum, an alloy including copper and molybdenum, and an alloy including copper and tungsten.

10. The apparatus of claim 1, wherein said substrate is a gallium arsenide substrate and said second metal is selected from the group of metals consisting of molybdenum, an alloy including copper and molybdenum, and an alloy including copper and tungsten.

11. The apparatus of claim 10, wherein said first metal is copper and said second metal is a 30:70 alloy of copper and molybdenum.

12. The apparatus of claim 1, wherein said first copper layer is under tensile strain.

13. Apparatus for cooling a diode-laser formed on a gallium arsenide substrate, comprising:
a body of a first metal, said metal body having channels therein for circulating a cooling fluid therethrough, and said body having first and second opposite surfaces;
first and second layers of a second metal bonded to respectively said first and second surfaces of said body, said second metal having a coefficient of thermal expansion (CTE) equal to or greater than that of said substrate but less than that of said first metal; and
first and second layers of layer of copper bonded to respectively said first and second layers of said second metal, said first and second copper layers each having a thickness less than that of respectively said first and second layers of said second metal, and being under tensile strain.

14. The apparatus if claim 13, wherein said first metal is copper.

15. The apparatus of claim 13, wherein said second metal is selected from the group consisting of molybdenum, an alloy of copper and molybdenum, and an alloy of copper and tungsten.

16. The apparatus of claim 15, wherein said first metal is copper.

17. The apparatus of claim 13, wherein said first and second layers of said second metal have about equal thickness and said first and second copper layers have about equal thickness.

18. Apparatus for cooling a diode-laser formed on a gallium arsenide substrate, comprising:
a copper body, said copper body having channels therein for circulating a cooling fluid therethrough, and said body having first and second opposite surfaces;
first and second layers of a second metal said second metal having a CTE equal to or greater than that of gallium arsenide but less than that of copper, said first and second layers bonded to respectively said first and second surfaces of said body; and
third and fourth layers of copper bonded to respectively said first and second layers, said third and fourth layers each having a thickness less than that of respectively said first and second layers and being under tensile strain.

19. The apparatus of claim 17, wherein said first and second layers have about equal thickness and said third and fourth layers have about equal thickness.

20. The apparatus of claim 19, wherein said second metal is one of molybdenum, an alloy of copper and molybdenum, and an alloy of copper and tungsten.

21. Apparatus for cooling a diode-laser formed on a semiconductor substrate, comprising:
a body of a first metal, said metal body having channels therein for circulating a cooling fluid therethrough, and said body having first and second opposite surfaces;
and a first layer of a second metal bonded to said first surface of said body, said second metal having a thermal conductivity greater than that of said first metal; and wherein
said first metal has a CTE about equal to or greater than that of said substrate and less that that of said second metal.

22. The apparatus of claim 21, further including a second layer of said second metal bonded to said second surface of said body.

23. The apparatus of claim 21, wherein the substrate is gallium arsenide, said first metal is one of molybdenum, an alloy of copper and molybdenum, and an alloy of copper and tungsten, and wherein said second metal is copper.

24. The apparatus of claim 21, wherein said first layer of said second metal is under tensile strain.

25. Apparatus for cooling a diode-laser formed on a semiconductor substrate, comprising:
a body of a first metal, said metal body, having first and second opposite surfaces;
a first layer of a second metal bonded to said first surface of said body, said second metal having a CTE equal to or greater than that of said substrate but less than that of said first metal; and
a first layer of a third metal bonded to said first layer of said second metal, said third metal having a CTE and a thermal conductivity greater than that of said second metal.

26. The apparatus of claim 25, wherein said first layer of said third metal has a thickness less than that of said first layer of said second metal.

27. The apparatus of claim 25, wherein said first layer of said third metal is under tensile strain.

28. The apparatus of claim 25, further including a second layer of said second metal bonded to said second surface of said metal body, said second layer of said second metal having a second layer of said third metal bonded thereto.

29. The apparatus of claim 28, wherein said first and second layers of said second metal are about equal in thickness, and said first and second layers of said third metal are about equal in thickness.

30. The apparatus of claim 25, wherein said first and third metals are the same metals.

31. A conduction cooled diode-laser apparatus comprising;
a diode laser formed on a semiconductor substrate:
a cooler, said cooler including a copper body having a fluid cooling channel formed therein;
a matching layer bonded onto the copper body, said matching layer formed from a metal having a coefficient of thermal expansion (CTE) greater than that of said substrate but less than copper; and
a copper heat spreading layer bonded to said matching layer in an manner to create tensile strain in the spreading layer, said spreading layer being bonded to said diode laser.

32. A conduction cooled diode-laser apparatus comprising:
a diode laser formed on a semiconductor substrate;
a cooler, said cooler including a metal body having a fluid cooling channel formed therein, said metal having a coefficient of thermal expansion (CTE) greater than that of said substrate but less than copper; and
a copper heat spreading layer bonded to said body in an manner to create tensile strain in the spreading layer, said spreading layer being bonded to said diode laser.

33. A method of making a cooler for use with a diode-laser formed on a semiconductor substrate, set method comprising the steps of:
assembling a structure including a copper body having a fluid cooling channel formed therein, a matching layer formed from a metal having a coefficient of thermal expansion (CTE) greater than that of said substrate but less than copper, and a copper heat spreading layer;
diffusion bonding the body, matching layer and heat spreading layer at an elevated temperature; and
cooling the assembly so that the copper heat spreading layer is in tensile strain.

34. A method of making a cooler for use with a diode-laser formed on a semiconductor substrate, set method comprising the steps of:
assembling a structure including a body and a copper heat spreading layer, said body having a fluid cooling channel formed therein and being formed from a metal having a coefficient of thermal expansion (CTE) greater than that of said substrate but less than copper;
diffusion bonding the body and the heat spreading layer at an elevated temperature; and
cooling the assembly so that the copper heat spreading layer is in tensile strain.

35. A method of making a cooler for use with a diode-laser formed on a semiconductor substrate, set method comprising the steps of:
assembling a structure including a metal body having a fluid cooling channel formed therein, a matching layer formed from a metal having a coefficient of thermal expansion (CTE) greater than that of said substrate but less than metal forming the body, and a heat spreading layer having a coefficient of thermal expansion (CTE) greater than that the metal of the matching layer;
diffusion bonding the body, matching layer and heat spreading layer at an elevated temperature; and
cooling the assembly so that the heat spreading layer is in tensile strain.

36. A method of making a cooler for use with a diode-laser formed on a semiconductor substrate, set method comprising the steps of:
assembling a structure including a body and a metal heat spreading layer, said body having a fluid cooling channel formed therein and being formed from a metal having a coefficient of thermal expansion (CTE) greater than that of said substrate but less than the heat spreading layer;
diffusion bonding the body and the heat spreading layer at an elevated temperature; and
cooling the assembly so that the heat spreading layer is in tensile strain.
